(19) United States
(12) Patent Application Publication
(10) Pub. No.: US 2019/0061278 A1
(43) Pub. Date: Feb. 28, 2019

(54) METHOD FOR MAKING PARTICLES

(71) Applicant: The Procter & Gamble Company, Cincinnati, OH (US)

(72) Inventors: Koen Mariette Albert Schamp, Beijing (CN); Pu Zhao, Beijing (CN)

(21) Appl. No.: 15/973,624

(22) Filed: May 8, 2018

(30) Foreign Application Priority Data
May 12, 2017 (WO) CN2017/084059

(51) Int. Cl. B29C 69/00; B29C 64/118; B29C 47/00

(52) U.S. Cl. CPC B29C 69/001; B29C 64/118; B29L 2031/601; B29C 47/0011; B29C 47/0028; B29C 47/003

(57) ABSTRACT

A method for making distinct particles is provided. The method includes the steps of: a) forming a block having a plurality of parallelly-arranged tubular structures by additive manufacturing, where the tubular structures each has a longitudinal axis and each is structurally connected with at least one adjacent tubular structure; b) splitting the block along the longitudinal axes of the tubular structures into a plurality of individual tubular structures that are structurally separated from each other; and c) slicing each of the individual tubular structures along a direction that traverses its longitudinal axis to form the distinct particles.

### FIELD OF THE INVENTION

The present invention is directed to a method for making particles by utilizing three-dimensional printing.

### BACKGROUND OF THE INVENTION

Distinct aesthetic particles that are water-dispersible have been generally used in cleaning compositions. These particles provide a visual cue to users connoting aesthetic or even functional benefits. For example, liquid or gel surfactant compositions containing a plurality of sheet-like elements as visual cues have been described. Previously described aesthetic particles are generally made by stamping or extruding techniques. This limits the design choices of the particles to rather simple ones. These simplistic designs may also limit the dissolution rate of the particles in water when these particles are incorporated into cleaning compositions. There is a need to provide distinct aesthetic particles that have more complex designs to provide a broader range of design capabilities.

A newly developed method for making aesthetic particles having more complex designs is to utilize additive manufacturing (also called three-dimensional (3D) printing). However, when conducting a 3D printing process, it is difficult and extremely slow/inefficient to print individual aesthetic particles one by one. Therefore, there is a need to provide an improved 3D printing method for making aesthetic particles with enhanced manufacturing speed and/or productivity.

### SUMMARY OF THE INVENTION

The present invention is based on the surprising discovery that multiple distinct aesthetic particles of more complex designs can be simultaneously formed by first 3D printing a block comprising a plurality of tubular structures, followed by splitting the block into individual tubular structures, and then slicing each of the tubular structures into multiple distinct aesthetic particles.

One advantage of the present invention is able to make aesthetic particles with hollow shapes, which requires less material and provides more aesthetics.

Another advantage of the present invention is that the block is easy for shipping and transportation, and thus avoiding breakage of aesthetic particles during intermediate handling. “Uncut” aesthetic particles can be stored and transported in the form of block or stack and subsequently “cut” at another site to form distinct aesthetic particles before they are added into a final product.

One aspect of the present invention provides a method for making distinct particles, comprising:

a) forming a block comprising a plurality of parallelly-arranged tubular structures by additive manufacturing, wherein the tubular structures each has a longitudinal axis and each is structurally connected with at least one adjacent tubular structure;

b) splitting the block along the longitudinal axes of the tubular structures into a plurality of individual tubular structures that are structurally separated from each other; and

c) slicing each of the individual tubular structures along a direction that traverses its longitudinal axis to form the distinct particles.

Preferably, the distinct particles are aesthetic particles.

Preferably, the additive manufacturing is fused deposition modeling (FDM).

Preferably, the splitting step b) is conducted by pushing the block through a cutter having at least two blades, where each of said at least two blades comprises a cutting plane that is parallel to the longitudinal axes of the tubular structures.

Preferably the cutter comprises multiple groups of blades, where each group comprises multiple blades that are arranged in parallel, and where said multiple groups of blades comprises at least two perpendicularly-arranged groups of blades.

Preferably, the slicing step c) is conducted along a direction that is perpendicular to the longitudinal axis of each of the tubular structures.

Another aspect of the present invention provides a method for making distinct particles, comprising:

a) forming a block comprising a plurality of parallelly-arranged tubular structures by additive manufacturing, wherein the tubular structures each has a longitudinal axis and each is structurally connected with at least one adjacent tubular structure;

b) slicing the block along a direction that traverses the longitudinal axes of the plurality of parallelly-arranged tubular structures into a plurality of segments, each of the segments comprising a plurality of distinct particles that each is structurally connected with at least one adjacent distinct particle; and

c) separating each of the segments into multiple distinct particles that are structurally separated from each other.

Preferably, the distinct particles are aesthetic particles. Preferably, each of the aesthetic particles comprises at least a through-hole. More preferably, each of the distinct aesthetic particles comprises at least two said through-holes.

Preferably, each of the aesthetic particles has a first side and a second side, and a thickness between the first side and second side ranging from 0.1 mm to 10 mm.

These and other aspects of the present invention will become more apparent upon reading the following detailed description of the invention.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, and in which:

FIG. 1 is a perspective representation of a block comprising a plurality of parallelly-arranged tubular structures, according to an embodiment of the present invention.

FIG. 2 is a schematic representation of an equipment for splitting the block of FIG. 1 into individual tubular structures, according to the present invention.

FIG. 3 is a schematic representation of slicing each of the individual tubular structures to form the distinct particles, according to the present invention.

FIG. 4 is a perspective view of a schematic representation of a distinct aesthetic particle made by the method of the present invention.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

As used herein, the articles including “the”, “a” and “an” when used in a claim or in the specification, are understood to mean one or more of what is claimed or described.

As used herein, the term “plurality” means more than one.

As used herein, the terms “comprise”, “comprising”, “include”, “including”, are meant to be non-limiting, i.e., other steps and other ingredients which do not affect the end of result can be added. Accordingly, the terms “consisting essentially of” and “consisting of” are embodied in the term “comprising”. As used herein, “consisting essentially of” means that the devices, apparatuses, methods, components, and/or compositions may include additional ingredients, but only if the additional ingredients do not materially alter the basic and novel characteristics of the claimed devices, apparatuses, methods, components, and/or compositions.

By “distinct” used herein in relation to the particle, it means that the particle is separate, i.e., not physically attached to other particles.

By “aesthetic” used herein in relation to the particle, it means that the particle has a designed or pre-determined, non-random size, shapes, and/or pattern to provide the consumer a visual appeal.

By “substantially the same” used herein in the context of shapes of two sides, it means that the two shapes can be either the same, or congruent, or similar. Two objects are congruent if one can be transformed into the other by a sequence of rotations, translations, and/or reflections. Two objects are similar if one can be transformed into the other by a uniform scaling, together with a sequence of rotations, translations, and/or reflections.

By “tubular structure” used herein, it means that an elongated structure having a longitudinal axis, which can have any cross-section shape, e.g. regular or irregular polygon (e.g., triangle, square, rectangle, etc.), circle, oval, petal, heart, and combinations thereof. Such “tubular structure” includes both solid items and items having through-holes extending along the longitudinal axis.

In this description, all concentrations and ratios are on a weight basis unless otherwise specified.

The present invention provides a method for making distinct particles. The method comprises a step a) of forming a block comprising a plurality of parallelly-arranged tubular structures, where the tubular structures each has a longitudinal axis and each is structurally connected with at least one adjacent tubular structure. Preferably, the block is made by additive manufacturing. The block could have any suitable dimensions, from several millimeters to several meters, as long as the additive manufacturing applies.

Preferably, each of the tubular structures has a cross-section with a perimeter shape selected from the group consisting of regular or irregular polygon (e.g., triangle, square, rectangle, etc.), circle, oval, petal, heart, and combinations thereof. Preferably, the perimeter shape is symmetric. More preferably, all the tubular structures have cross-sections with substantially the same perimeter shape.

Additive manufacturing (AM), also known as three-dimensional (3D) printing, refers to various processes used to synthesize a three-dimensional object. Available 3D printing techniques include fused deposition modeling (FDM) (extrusion-based technique), ink jetting, selective laser melting (SLM), selective heat sintering (SHS), powder/binder jetting, electron-beam melting (EBM), and stereolithographic processes. For example, fused deposition modeling (PDM) is a most common type of 3D printing, which is a classic application of plastic extrusion. In PDM process for the present invention, the aesthetic particle is produced by extruding small beads of raw material which harden immediately to form layers. A filament of raw material which is wound on a coil is unreeled to supply material to an extrusion nozzle head (3D printer extruder). The nozzle head heats the material and turns the flow on and off. Typically, the extrusion head is moved by stepper motors or servo motors along 3 axes of motion. A computer-aided manufacturing (CAM) software package is used to generate the G-Code that is sent to a microcontroller for moving the motors.

In one embodiment, the additive manufacturing is conducted by laying a first layer of individual strips of raw materials, where such individual strips of raw materials extend along a horizontal direction, and then laying subsequent layers of additional individual strips of raw materials on top of said first layer, where additional individual strips of raw materials also extend along the horizontal direction, thereby forming the plurality of parallelly-arranged tubular structures. In this case, the longitudinal axis of the parallelly-arranged tubular structures is parallel to the horizontal direction.

The method of the present invention further comprises a step b) of splitting the block along the longitudinal axes of the tubular structures into a plurality of individual tubular structures which are structurally separated from each other. The splitting step can be conducted by pushing the block through a cutter having at least two blades. The at least two blades each have a cutting plane parallel to the longitudinal axes of the tubular structures so that the tubular structures are cut through by the blades along the planes. Depending on how the tubular structures structurally connected with each other, the at least two blades can be arranged at an angle towards each other. For example, the at least two blades can comprise two blades perpendicular to each other. The at least two blades can be arranged offset with or without contacting each other. In some cases, the cutter has at least two groups of blades, where each group comprises multiple blades that are arranged in parallel, and preferably said multiple groups of blades comprises at least two perpendicularly-arranged groups of blades. Alternatively, the cutter can have two groups of blades which are assembled together without any distance in between to form a mesh cutter.

The method of the present invention further comprises the step c) of slicing each of the individual tubular structures along a direction that traverses its longitudinal axis to form the distinct particles. In a preferred but not necessary embodiment, the slicing step can be conducted along a direction that is perpendicular to the longitudinal axis of each of the tubular structures. Alternatively, the slicing step can be conducted along a direction that constitutes a degree less than 90° with respect to the longitudinal axis of each of the tubular structures. In some embodiments, the slicing step can be conducted by slicing a plurality of structurally-separated individual tubular structures in bundle, immediately after the tubular structures are split through a cutter as described, to form multiple distinct particles. In other embodiments, the slicing step can be conducted by slicing each of the plurality of individual tubular structures separately.

Another aspect of the present invention provides a method for making distinct particles, preferably distinct aesthetic particles. The method comprises the steps of: a) forming a block comprising a plurality of parallelly-arranged tubular structures by additive manufacturing, where the tubular structures each has a longitudinal axis and each is structurally connected with at least one adjacent tubular structure.

The method further comprises a step b) of slicing the block along a direction that traverses the longitudinal axes of the plurality of parallelly-arranged tubular structures into a plurality of segments, such that each of the segments comprises a plurality of distinct aesthetic particles that each is structurally connected with at least one adjacent distinct aesthetic particle. Preferably, the slicing step is conducted along a direction perpendicular to the longitudinal axes of the tubular structures.

The method further comprises a step c) of separating each of the segments into multiple distinct aesthetic particles, such that the multiple distinct aesthetic particles are structurally separated from each other.

### Aesthetic Particles

The distinct aesthetic particle of the present invention comprises a first side and a second side. Preferably, the first side is planar, more preferably the second side is also planar. In some embodiments, the first side and the second side are parallel to each other. The first side of the particle has a length from 0.2 mm to 20 mm Preferably, the length of the first side is from 1 mm to 10 mm. “Length” of a side herein means the longest linear distance between any two points of the side. A thickness of the particle is defined as the distance between the first side and the second side. The thickness range of the particle may be from 0.1 mm to 10 mm, preferably from 0.2 mm to 5 mm, more preferably from 0.2 mm to 2.5 mm.

Preferably, each of the distinct aesthetic particles comprises at least a through-hole. Herein the “through-hole” means a hole completely through the material of the particle extending between the first side and the second side. More preferably, each of the distinct aesthetic particles comprises at least two through-holes.

### Shape

The aesthetic particles of the present invention may have a pre-determined, non-random, desirable shape on the first side and/or the second side. The side(s) may have a shape defined by its periphery, i.e., a perimeter shape. In some embodiments, the first side comprises a first perimeter shape, wherein the first perimeter shape has symmetry. Herein the symmetry has the general meaning in geometry. Preferably, the symmetry may include mirror symmetry and/or radial symmetry. In other embodiments, the second side has a second perimeter shape wherein the second perimeter shape has symmetry. In other embodiments, the first perimeter shape is substantially the same as the second perimeter shape. In some examples, the side(s) may have a perimeter shape selected from the group consisting of a circle, an oval, a heart, a regular or irregular polygon, a pedal, a letter, a number, and combinations thereof. For example, the side(s) may have perimeter shape in the form of a regular polygon shape, such as triangle, square, rectangle, quadrilateral, star, pentagon, hexagon, heptagon, and octagon. In another example, the particle has a first side having a perimeter shape of a heart.

### Materials

The particles of the present invention can be made of any material suitable for 3D printing. In some embodiments, the particles can be made of a water-dispersible material. Herein “water-dispersible” used in relation to a material or a particle means that a material or particle is capable of being dispersed in an aqueous solvent (e.g. water) to form a stable mixture (homogeneous or heterogeneous) at ambient conditions. Preferably, the particles of the present invention can be made of water-soluble materials. “Water-soluble” material as used herein means a material that is miscible in water. Preferably the material that is capable of forming a stable homogeneous solution with water at ambient conditions.

The water-soluble material used herein may be selected from the group consisting of water-soluble hydroxyl polymers, water-soluble thermoplastic polymers, water-soluble biodegradable polymers, water-soluble non-biodegradable polymers and combinations thereof. Preferably, the water-soluble material is selected from the group consisting of pullulan, hydroxypropylmethyl cellulose, hydroxyethyl cellulose, hydroxypropyl cellulose, polyvinyl pyrrolidone, carboxymethyl cellulose, sodium alginate, xanthan gum, tragacanth gum, guar gum, acacia gum, Arabic gum, polyacrylic acid, methylmethacrylate copolymer, carboxyvinyl polymer, dextrin, pectin, chitin, levan, elsinan, collagen, gelatin, zein, gluten, soy protein, casein, polyvinyl alcohol, starch, starch derivatives, hemicellulose, hemicellulose derivatives, proteins, chitosan, chitosan derivatives, polyethylene glycol, tetramethylene ether glycol, hydroxymethyl cellulose, fatty acids and combinations thereof. In an embodiment, the water-soluble material is polyvinyl alcohol. In another embodiment, the water-soluble material is polyethylene glycol.

Optionally, the particles of the present invention may further comprise active agent(s). Active agents are a class of additives that are designed and intended to provide a benefit to something other than the particle itself, such as providing a benefit to an environment external to the particle. Active agents may be any suitable additive that produces an intended effect under intended use conditions of the particle. For example, the active agents can be selected from the group consisting of: skin benefit agents, medicinal agents, lotioning agents, fabric care agents, dishwashing agents, carpet care agents, surface care agents, hair care agents, air care agents, and combinations thereof.

The particles may have color which provides visual contrast to the bulk of the cleaning composition. Preferably, the particle of the present invention may have more than one color so that visually distinguishable patterns with different colors can be achieved. Any dye or pigment capable of imparting a visually distinguishable color can be included in the particle.

### EXAMPLES

### Example 1

### Three-Dimensional Printing a Particle

3D printer instrument MakerBot Replicator 2X Hyrel 30M System (MakerBot Industies. LLC, NY, USA) is used to make a block having 2×2 tubular structures.

Step a): Forming the Block by 3D Printing

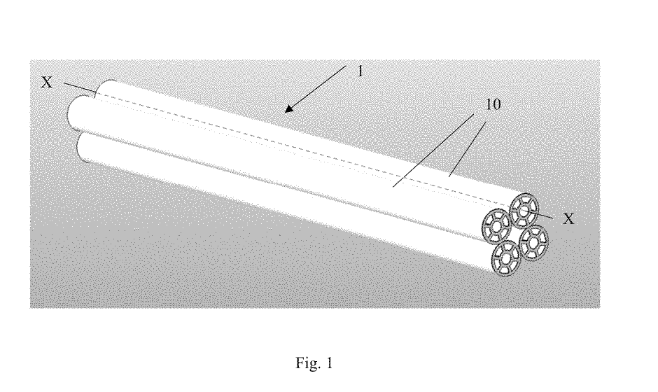

A block structure 1 showed in FIG. 1 is 3D printed using a water-soluble polyvinyl alcohol (PVA) filament having a diameter of 1.75 mm, which is available from ESUN (Shenzhen Esun Industrial Co., Ltd.). The cross-section shape of aesthetic particles is a circle having an outer ring and a concentric inner ring and six walls connecting the outer ring and the inner ring, as shown in FIG. 1. The shape is designed using 3D model design software Autodesk 123D Design 1.6.41 and saved as a *.stl file. A 3D model is designed by increasing the dimension perpendicular to the circular cross-section of the shape into tubular structure and then duplicating the tubular structure into 2×2 parallelly-arranged tubular structures which are structurally connected to each other. The designed model is converted to 3D slicing software MakerBot Desktop 3.9.1.1143; and the printer parameters are set as follows.

Layer height 0.1 mm.

Coarseness 0.0001 mm.

Infill density 200%.

Extruder temperature 190° C.

Platform temperature 60° C.

The block is printed layer by layer horizontally, i.e., the nozzle head moves along a horizontal direction, and then laying subsequent layers of additional individual strips of raw materials on top of said first layer, where additional individual strips of raw materials also extend along the horizontal direction, thereby forming the plurality of parallelly-arranged tubular structures.

FIG. 1 is a perspective view of a schematic representation of the block 1 according to the present invention. Referring to FIG. 1, the block 1, made by a 3D printer, comprises a 2×2 parallelly-arranged tubular structures 10, where the tubular structures each has a longitudinal axis X-X and each is structurally connected with at least one adjacent tubular structure. The printed block is 200 mm in length, 10 mm in height, and 10 mm in width.

Step b): Splitting Into Individual Tubular Structures

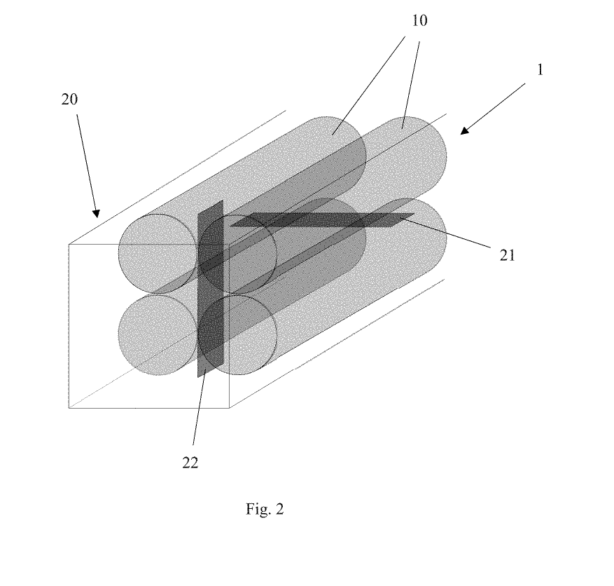

FIG. 2 shows a perspective view of a schematic representation of a cutter 20 for splitting the block 1 shown in FIG. 1 into individual tubular structures 10, according to the present invention. In FIG. 2, the cutter 20 has two blades (21, 22) which are parallel to the longitudinal axis X-X (shown in FIG. 1) of the tubular structures 10 respectively, while the two blades (21, 22) are perpendicular to each other and arranged in the cutter tunnel offset. The block 1 is pushed into the cutter 20 through the blades 21 and 22 subsequently, and is split into 4 (four) individual tubular structures 10.

Step c): Slicing into Distinct Particles

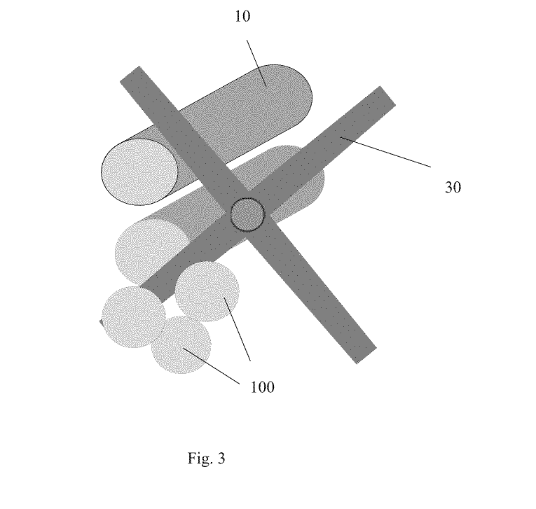

A fan-like slicer is used to slice the obtained individual tubular structures into distinct particles. FIG. 3 is a schematic representation of slicing the structurally-separated individual tubular structures 10 obtained from the step b) to form the distinct particles 100, via a fan-like slicer 30. The fan-like slicer is driven by a motor and rotates along a plane which is perpendicular to the longitudinal axis of the tubular structure.

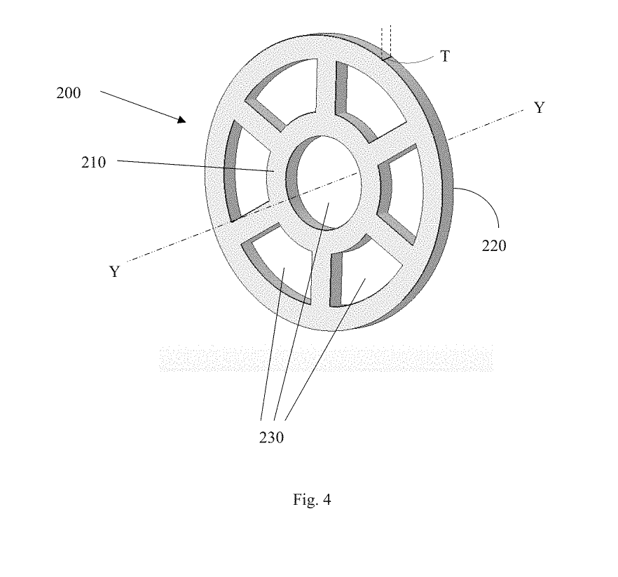

FIG. 4 shows a perspective view of a schematic representation of a distinct particle 200 made by the method of the present invention. The particle 200 has a first side 210 and a second side 220, where the first side 210 has a first planar surface, and the second side 220 has a second planar surface. Due to the cutting method described in the above Example, the first planar surface and the second planar surface are parallel to each other, and both are orthogonal to a longitudinal axis Y-Y. The perimeter of the first side 210 forms a perimeter shape in the form of a circle. Although not visible in the figures, a perimeter of the second side 220 forms a perimeter shape also in the form a circle. The particle 200 comprises a thickness (T) defined by the distance between the first side 210 and the second side 220 (along the longitudinal axis Y-Y). The particle 200 comprises a plurality of through holes 230 extending between the first side 210 and the second side 220.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for making distinct particles, comprising:
a) forming a block comprising a plurality of parallelly-arranged tubular structures by additive manufacturing, wherein the tubular structures each has a longitudinal axis and each is structurally connected with at least one adjacent tubular structure;
b) splitting the block along the longitudinal axes of said tubular structures into a plurality of individual tubular structures that are structurally separated from each other; and
c) slicing each of the individual tubular structures along a direction that traverses its longitudinal axis to form the distinct particles.

2. The method according to claim 1, wherein the additive manufacturing is fused deposition modeling (FDM).

3. The method according to claim 1, wherein the splitting step b) is conducted by pushing the block through a cutter having at least two blades, wherein each of said at least two blades comprises a cutting plane that is parallel to the longitudinal axes of the tubular structures.

4. The method according to claim 3, wherein the cutter comprises multiple groups of blades, wherein each group comprises multiple blades that are arranged in parallel, and wherein said multiple groups of blades comprise at least two perpendicularly-arranged groups of blades.

5. The method according to claim 1, wherein the slicing step c) is conducted along a direction that is perpendicular to the longitudinal axis of each of the tubular structures.

6. A method for making distinct particles, comprising:
a) forming a block comprising a plurality of parallelly-arranged tubular structures by additive manufacturing, wherein the tubular structures each has a longitudinal axis and each is structurally connected with at least one adjacent tubular structure;
b) slicing the block along a direction that traverses the longitudinal axes of the plurality of parallelly-arranged tubular structures into a plurality of segments, each of the segments comprising a plurality of distinct particles that each is structurally connected with at least one adjacent distinct particle; and
c) separating each of the segments into multiple distinct particles that are structurally separated from each other,
wherein the distinct particles are aesthetic particles.

7. The method according to claim 1, wherein each of the tubular structures has a cross-section with a perimeter shape selected from the group consisting of regular or irregular polygon, circle, oval, petal, heart, and combinations thereof; preferably the perimeter shape is symmetric; more preferably all the tubular structures have cross-sections with substantially the same perimeter shape.

8. The method according to claim 1, wherein each of the distinct particles comprises at least a through-hole, preferably each of the distinct particles comprises at least two said through-holes.

9. The method according to claim 1, wherein each of the distinct particles has a first side and a second side, and a thickness between the first side and second side ranging from 0.1 mm to 10 mm.
